(19) United States
(12) Patent Application Publication
(10) Pub. No.: US 2015/0212660 A1
(43) Pub. Date: Jul. 30, 2015

(54) SYSTEM AND METHOD FOR DISPLAYING MULTIPLE APPLICATIONS

(71) Applicant: XIAOQIANG SU, Fremont, CA (US)

(72) Inventor: XIAOQIANG SU, Fremont, CA (US)

(21) Appl. No.: 14/164,127

(22) Filed: Jan. 24, 2014

(51) Int. Cl. G06F 3/0482; G06F 3/0481

(52) U.S. Cl. CPC G06F 3/0482; G06F 3/04817

(57) ABSTRACT

A method and system for display a plurality of application windows on a workspace without resizing or overlapping any application windows by organizing the application windows into an ordered list. The organized list of application windows are displayed side by side in a virtual display region. At least a portion of the virtual display region is viewable on the workspace. When a new application window is requested, it will be inserted into the ordered list according to a predetermined order rule. The updated ordered list of application windows are then redisplayed in the virtual display region and the viewable portion of the virtual display region on the workspace is recalculated.

### CROSS-REFERENCE TO RELATED APPLICATIONS

This application relates to and claims the benefit of U.S. Provisional Patent Application No. 61/756,481 filed Jan. 25, 2013.

### STATEMENT REGARDING FEDERALLY SPONSORED RESEARCH OR DEVELOPMENT

Not applicable.

### TECHNICAL FIELD

The present invention relates to a graphical user interface. More specifically, the present invention relates to a system and method for arranging application display regions on a graphical user interface.

### BACKGROUND OF THE INVENTION

It is usually possible and desirable to have multiple applications simultaneously run on a graphical user interface display area, with each application program presenting information and/or means for interaction to the user within a bounded region by drawing images, graphics or text within the region. The graphical user interface could be a PC desktop or a mobile device view port where single or multiple software applications are displayed to a user in separate “windows”, or a web browser running on a computer system where multiple web applications can be displayed and interacted with a user. For convenience of description, an application display region will be simply referred as “application window” or “window” in the following description and the graphical user interface display area will be simply referred as “workspace”.

A problem is that when several applications are opened simultaneously, the workspace may assume a cluttered or disorganized appearance. Some of the application window or display region can overlay other application window or display region, causing obscure of useful information, and thus causing inconvenience to the user and reducing the workspace efficiency. This is particularly annoying when a new application window is created and displayed overlaying an otherwise actively displayed application window, when the user interacts with the application window, and causes the suspension of such interaction. Furthermore, the application windows can be difficult to navigate when the user try to switch from one application window to another one.

There are techniques (e.g., “tile”, “cascade” and “tab”) that try address the problem by providing automated arrangement of application windows on the workspace. However, these techniques either requiring resizing, overlapping application windows or total switching of application windows and do not address the problem sufficiently and present drawbacks.

### SUMMARY OF THE INVENTION

An embodiment of the present invention provides a method and system for arranging application windows on a workspace without resizing or overlapping any application windows. According to one embodiment of the present invention, to display a plurality of application windows on a workspace, a method of affecting a workspace is provided, comprising the steps of:
a) organizing a group of application windows that is to run on the workspace into an ordered list;
b) creating a virtual display region for the ordered list of application windows; sizing the virtual display region to have at least a width of the total width of the application windows plus predetermined spacings;
c) causing the application windows on the list to display side by side separated by predetermined spacings within the virtual display region in the orders of the application windows on the list;
d) determining the portion of the virtual display region to be viewable on the workspace by determining the offset of the virtual display region relative to the workspace;

According to the present invention, a method of adding a new application window (child application window) to the workspace due to a user interaction with an already displayed application window (parent application window), comprising the steps of:
a) organizing an group of application windows that is to run on the workspace into an ordered list;
b) inserting the child application window to the ordered list next to (right after or right before) the parent application within the list;
c) re-displaying the new list of application windows according to the method of displaying a plurality of application windows on a workspace as revealed in the present invention.

### BRIEF DESCRIPTION OF THE DRAWINGS

The present invention is illustrated by way of example, and not by way of limitation, and can be more fully understood with reference to the following detailed description when considered in connection with the figures in which:

FIG. 1. depicts a workspace displaying a plurality of application windows according to the preferred embodiment of the present invention;

FIG. 2. shows schematically the coordinate system that is used to identified the application windows.

FIG. 3. illustrates adding a new application window to the workspace displaying a plurality of application windows of FIG. 1.

### DETAILED DESCRIPTION OF THE INVENTION

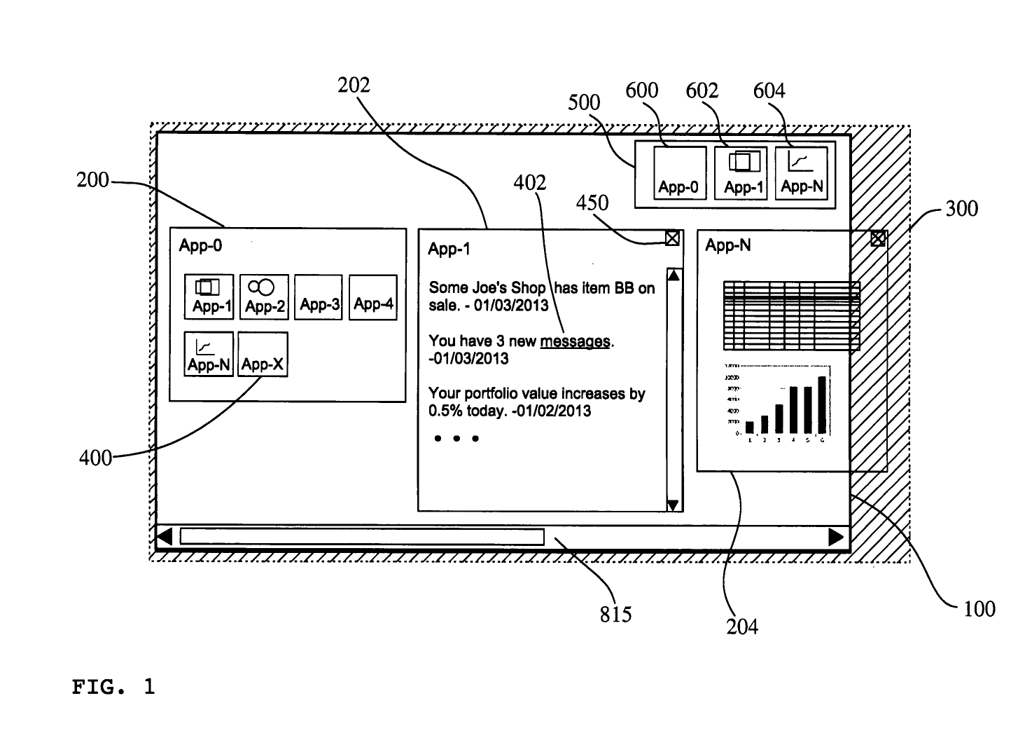

With reference to FIG. 1, there is depicted a workspace 100 that is utilized to display a initial set of plurality of application windows 200, 202, and 204. The application windows are organized into an ordered list, with the order determined by a predetermined rule. In one embodiment, the order may be determined by the time stamp when an application window is initially displayed on the workspace. In an alternative embodiment, the order may be simply assigned by a recorded user's preferences. They are displayed on the workspace through a virtual display region 300 by positioning side by side within the virtual display region, at least a portion of which is viewable on the workspace 100 (the shade area indicates the unviewable portion of the virtual display region that is positioned outside the workspace). Typically, an application window presents information and/or means for interaction to the user within a bounded region by drawing images, graphics or text. An application window such as application window 200 or 202 may further include links such as links 400 or 402 that a user is to perform to launch new application windows. In the preferred embodiment, an application window such as 202 may be further assigned an indication of action 450 that the user can perform to remove the application window from display on the workspace. In the preferred embodiment, the workspace 100 may further include an application index display region 500 that is always viewable on the workspace. The application index display region 500 includes for each application window 4, displayed on the workspace 100 a link object such as link objects 600, 602, and 604 that are assigned to each displayed application windows 200, 202 and 204. Each link object such as 602 may contain text and or icon to uniquely identify the link object. In the preferred embodiment, the link objects are arranged in the same order of the application windows. The user is to perform on a link object such as 602 to cause the computer system to determine the viewable portion of the virtual display region 300 on the workspace 100. The workspace may further include a scrollbar 815 that a user can perform to cause change of the viewable portion of the virtual display region 300 on the workspace.

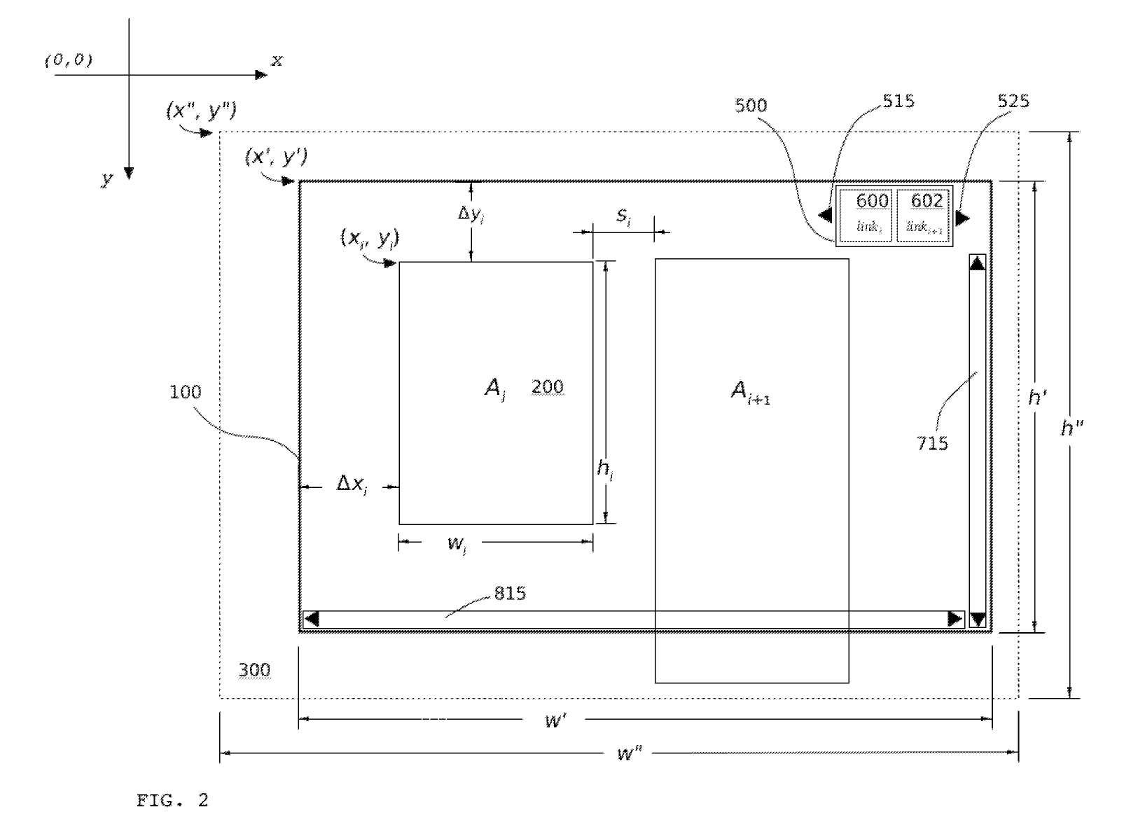

With reference to FIG. 2, there is depicted schematically the coordinate system that is used to identified the application windows. In the preferred embodiment of the present invention, the application windows (N total number) are organized into an ordered list, [A₁. . . , Aᵢ,Aᵢ₊₁, . . . A_{N}] with the order determined by a predetermined rule. For example, the order may be determined by the time stamp when an application window is initially displayed on the workspace 100. Another example, the order may be simply assigned by a user's preferences. An application window A, 200 that is displayed on the workspace 100 is identified by a set of properties,
(xᵢ,yᵢ) are the coordinates of the application window Aᵢ with reference to the virtual display region coordinate (x″,y″);
Δxᵢ,Δyᵢ are respectively the predetermined x offset from the right edge of workspace and y offset of the application window Aᵢ from the top edge of the workspace when the application window is in focus;
wᵢ,hᵢ are respectively the predetermined width and height of the application window Aᵢ;
sᵢ is the predetermined spacing between the application window Aᵢ and the immediately next application window Aᵢ₊₁ on the ordered list.
[A₁, . . . , Aᵢ,Aᵢ₊₁, . . . A_{N}];

The workspace 100 has a width of w′ and a height h′ and a location (x′,y′). According to the preferred embodiment of the present invention, the application windows would be arranged side by side within a virtual display region 300 as if the virtual display region can be expanded indefinitely along the x-axis to have a width w″ of at least the width of w₀+Σᵢ₌₁^{N}(wᵢ+sᵢ) to contain all the application windows in the ordered list, such that the application window Aᵢ₊₁ in the ordered list w [A₁, . . . , Aᵢ,Aᵢ₊₁, . . . A_{N}] will be positioned according to the following recursive rule:

xᵢ₊₁=xᵢ+wᵢ+sᵢ

x₁=w₀

with w₀ as a constant offset.

It is further preferred that

yᵢ₊₁=yᵢ=y₀

with y₀ as a constant offset.

The virtual display region height h″ is at least the height of the tallest application window's height, max(h₁, . . . , hᵢ,hᵢ₊₁, . . . h_{N}).

According to the preferred embodiment of the present invention, when application window Aᵢ 200 is in focus, it is preferred that the application window is displayed at the location with predetermined offsets Δxᵢ to the left edge of the workspace and Δyᵢ to the top edge of the workspace. Therefore, viewable portion of the virtual display region 300 is determined according to the relative positions of the virtual display region to the workspace 100 defined by

xᵢ−x′=Δxᵢ, or

x″+w₀+Σₖ₌₁ⁱ⁻¹(wₖ+sₖ)−x′=Δxᵢ, therefore,

x″−x′=Δxᵢ−w₀−Σₖ₌₁ⁱ⁻¹(wₖ+sₖ)

That is, the display region 300 is displayed relative to the workspace 100 by an x-axis offset defined by x″−x′ in the above formula and y-axis offset y″−y′=Δyᵢ. According to one embodiment of the present invention, the height of an application window is at maximum the height of the workspace minus Δyᵢ and the width of an application window is at maximum the width of the workspace minus Δxᵢ such that when an application window is in focus, the application window is completely viewable within the workspace. According to an alternative embodiment of the present invention, the width and height of an application window may take any positive number, and in case the height of any application window on the workspace exceeds the limit defined above and thus causing portion of the virtual display region 300 along the y-axis to be unviewable within the workspace, a means such as a vertical scrollbar 715 is provided on the workspace that the user is to perform to cause different portion of the virtual display region 300 along the y-axis viewable within the workspace. It is also noted that after certain number of application windows are displayed within the virtual display region 300, the width of the virtual display region will be greater than the width of the workspace. It is then generally preferable that a means such as a horizontal scrollbar 815 is provided on the workspace that the user is to perform to cause different portion of the virtual display region 300 along the x-axis viewable within the workspace.

According to the preferred embodiment of the present invention, the workspace 100 further includes an application index display region 500. The application index display region 500 includes for each application window Aᵢ displayed on the workspace 100 a link object such as 600 and 602. That is, for the list of application windows, [A₁, . . . , Aᵢ,Aᵢ₊₁, . . . A_{N}], there is created an ordered list [L₁, . . . , Lᵢ,Lᵢ₊₁, . . . L_{N}], where Lᵢ is the link object that is mapped to the application window Aᵢ and that a user is to perform to bring the application window Aᵢ into focus. In one embodiment, each link object is bounded in square regions of the same dimension with width of d and separated by spacing of g. The application index display region 500 is then assigned a width w′″ of max(wₘₐₓ′″,N×(d+g)+g) and height h′″ of d+2×g. Here wₘₐₓ′″ is a predetermined number generally greater than d=2×g and less than the workspace width w′. And it is generally preferred that wₘₐₓ′″ is chosen in a way such that region 500 can display an exact integer number M of link objects, that is wₘₐₓ′″=M×(d+g)+g, M≦N.

The application index display region 500 is preferably always viewable and positioned on a side part of the work space, for example, with its top left corner fixed at the coordinate of (w′−w′″,0) regardless of the viewable portion of the application windows virtual display region 300. In the case that, when the number of application windows displayed on the workspace causes N×(d+g)+g>wₘₐₓ′″, it is noted then that at any given time, the application index display region 500 will be only have M (M<N) number of link objects viewable on display, with the sublist denoted as [Lₖ,Lₖ₊₁, . . . , L_{k+M}]. In this case, it is then further preferable that the application index display region 500 includes scroll means such as 515 and 525 that a user is to perform to cause the change of the viewable sublist of link objects, comprising the steps of:
a) when the means 515 is clicked, determine whether k>1 or not, if yes, then shift the viewable sublist according to k_{new}=k−1, so that the new viewable sublist of link objects becomes [Lₖ₋₁,Lₖ, . . . , L_{k+M-1}]
b) when the means of 525 is clicked, determine whether k+M<N or not, if yes, then shift the viewable sublist according to k_{new}=k+1, so that the new viewable sublist of link objects becomes [Lₖ₊₁,Lₖ₊₂, . . . , L_{k+M+1}]

According to the preferred embodiment of the present invention, an application window can be brought into focus by a user clicking on a link object that is assigned to the application window, or when it is first added to the workspace by default or by a user clicking on a link within an application window that causes the launch of the new application window.

According to the preferred embodiment of the present invention, a method of adding a new application window (child application window) A_{new} to the workspace due to a user interaction with an already displayed application window (parent application window) Aᵢ, comprising the steps of:
1. determining the existing ordered list of application windows displayed on the workspace, [A₁, . . . , Aᵢ,Aᵢ₊₁, . . . A_{N}] and determining the location of Aᵢ within the ordered list;
2. creating the child application window A_{new} with predetermined properties Δx_{new},Δy_{new},w_{new},h_{new} and s_{new};
3. inserting the child application window A_{new} to the ordered list next to (e.g., right after) the parent application window within the list, and the ordered list becomes [A₁, . . . , Aᵢ,A_{new},Aᵢ₊₁, . . . A_{N}];
4. creating a new link object L_{new} for application window A_{new} and updating the link objects list [L₁, . . . , Lᵢ,Lᵢ₊₁, . . . L_{N}] accordingly to [L₁, . . . , Lᵢ,L_{new},Lᵢ₊₁, . . . L_{N}];
5. bringing the child application window A_{new} into focus and re-displaying the updated ordered list of application windows [A₁, . . . , Aᵢ,A_{new},Aᵢ₊₁, . . . , A_{N}] according to the method of displaying a plurality of application windows on a workspace as revealed in the present invention.

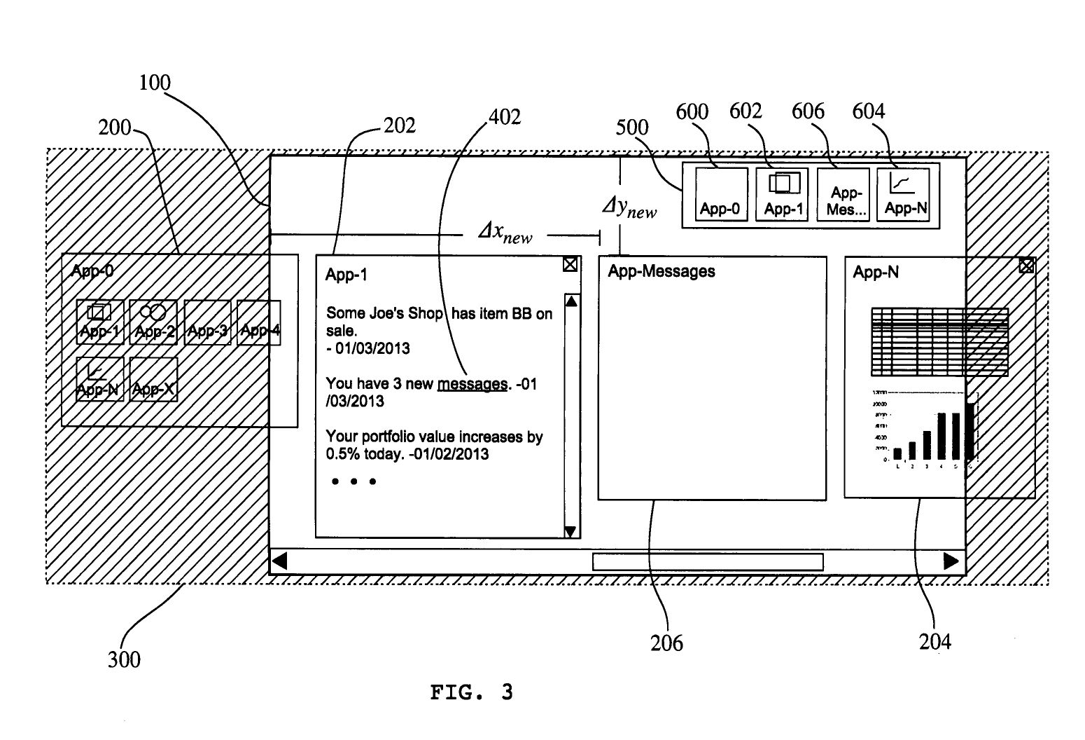

With reference to FIG. 3, there illustrates the layout of workspace 100 of FIG. 1, after a user clicks the application link 402 within the application window 202. At the beginning, the workspace displayed the list of application windows 200, 202 and 204 organized into the virtual display region 300 as described in FIG. 1. The workspace also includes the application index display region 500, which at the beginning displayed the list of link objects 600, 602 and 604 that the user can click to bring the application windows 200, 202 and 204 into focus respectively according to the method revealed in the present application. After the user clicks the application link 402 within the application window 202, a new application window 206 is created and inserted in between the application windows 202 and 204. That is, the ordered list of application windows displayed on the workspace now becomes 200, 202, 206 and 204. The new application window 206 is brought into focus according to the method revealed in the present invention. Accordingly, a new link object 606 is also created and displayed in between object link 602 and 604 on the application index display region 500. That is, the list of link objects now becomes 600, 602, 606 and 604.

What is claimed is:

1. A machine-implemented method of displaying a plurality of application windows on a display, comprising the steps of:
organizing a group of one or more application windows into an ordered list;
displaying the ordered list of application windows in a non-overlapping manner such that at least part of one application window is viewable on the display, wherein the one application window includes at least one indication of action to display a new application window;
receiving an input to create and display a new application window, wherein the input comprises receiving a selection of the indication of action of the one application window;
updating the ordered list by inserting the new application window into the ordered list such that the orders of the application windows are preserved;
positioning the updated ordered list of application windows in a non-overlapping manner according to the order of the new ordered list such that at least a part of the new application window is viewable on the display.

2. The method of claim 1, wherein said one application window is the first application window on the ordered list.

3. The method of claim 1, wherein updating the ordered list is by inserting the new application window next to said one application window on the ordered list.

4. The method of claim 1, wherein the display is a PC desktop.

5. The method of claim 1, wherein the display is a web browser and the application windows are web applications.

6. The method of claim 1, wherein positioning the ordered list of application windows in a non-overlapping manner comprises steps of:
creating a virtual display region for the list of application windows such that the virtual display region have at least a width of the total width of the application windows plus predetermined spacings and such that the virtual display region have at least a height of the highest height of the application windows;
causing the application windows on the list to position side by side separated by predetermined spacings within the virtual display region in the orders of the application windows on the ordered list;
determining the portion of the virtual display region to be viewable on the display by determining the offset of the virtual display region relative to the display.

7. The method of claim 1 further includes:
creating an application index display region on the display, wherein the application index display region includes for each application windows on the ordered list a link object such that each link object is identifiable by a text or an icon or a text and an icon combined and can be used to uniquely identified to an application window on the ordered list;
receiving a selection of a link object and uniquely identifying an application window;
repositioning the ordered list of application windows such that at least part of the uniquely identified application window to be viewable on the display.

8. The method of claim 7 further includes:
creating and adding a new link object to the application index display region when a new application window is inserted into the ordered list such that the new link object is identifiable by a text or an icon or a text and an icon combined and can be uniquely mapped to the new application window.

9. An article of manufacture comprising a non-transitory program storage medium readable by a computer, the medium tangibly embodying one or more programs of instructions executable by the computer to perform a method of displaying a plurality of application windows on a display, comprising the steps of:
organizing a group of one or more application windows into an ordered list;
displaying the ordered list of application windows in a non-overlapping manner such that at least part of one application window is viewable on the display, wherein the one application window includes at least one indication of action to display a new application window;
receiving an input to create and display a new application window, wherein the input comprises receiving a selection of the indication of action of the one application window;
updating the ordered list by inserting the new application window into the ordered list such that the orders of the application windows are preserved;
positioning the updated ordered list of application windows in a non-overlapping manner according to the order of the new ordered list such that at least a part of the new application window is viewable on the display.
